(19) United States
(12) Patent Application Publication
(10) Pub. No.: US 2020/0143238 A1
(43) Pub. Date: May 7, 2020

(54) Detecting Augmented-Reality Targets

(71) Applicant: Facebook, Inc., Menlo Park, CA (US)

(72) Inventors: Krishnan Ramnath, Redmond, WA (US); Shanghsuan Tsai, Sunnyvale, CA (US)

(21) Appl. No.: 16/183,683

(22) Filed: Nov. 7, 2018

(51) Int. Cl. G06N 3/08; G06F 17/30

(52) U.S. Cl. CPC G06N 3/08; G06F 17/30256

(57) ABSTRACT

In one embodiment, a method includes receiving deep-learning (DL)-feature representations and local-feature descriptors, wherein the DL-feature representations and the local-feature descriptors are extracted from an image that includes a first depiction of a real-world object; identifying a set of potentially matching DL-feature representations based on a comparison of the received DL-feature representations with stored DL-feature representations associated with a plurality of augmented-reality (AR) targets; determining, from a set of potentially matching AR targets associated with the set of potentially matching DL-feature representations, a matching AR target based on a comparison of the received one or more local-feature descriptors with stored local-feature descriptors associated with the set of potentially matching AR targets, wherein the stored local-feature descriptors are extracted from the set of potentially matching AR targets; and sending, to the client computing device, information configured to render an AR effect associated with the determined matching AR target.

### TECHNICAL FIELD

This disclosure generally relates to augmented reality environments.

### BACKGROUND

Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

AR effects are computer-generated visual effects (e.g., images and animation) that are superimposed or integrated into a user's view of a real-world scene. Certain AR effects may be configured to track objects in the real world. For example, a computer-generated unicorn may be placed on a real-world table as captured in a video. As the table moves in the captured video (e.g., due to the camera moving or the table being carried away), the generated unicorn may follow the table so that it continues to appear on top of the table. To achieve this effect, an AR application may use tracking algorithms to track the positions and/or orientations of objects appearing in the real-world scene and use the resulting tracking data to generate the appropriate AR effect. Since AR effects may augment the real-world scene in real-time or near real-time while the scene is being observed, tracking data may need to be generated in real-time or near real-time so that the AR effect appears as desired.

### SUMMARY OF PARTICULAR EMBODIMENTS

In particular embodiments, a computing device may access an image of a real-world environment that may contain one or more depictions of real-world objects that are intended targets for AR effects. For example, this computing device may be a client computing device such as a smartphone that is viewing a real-world environment that includes a Cowboy RoboNinja movie poster for which an AR effect exists (e.g., on a server database). An initial feature map may be generated for the image using a first machine learning model. A separate machine learning model may then be used to identify likely regions of interest within the feature map and the corresponding image. Building on the previous example, if posters are targets of interest for an AR effect, a machine learning model residing on the smartphone may identify a region within the feature map corresponding to the portion of the image that includes the Cowboy RoboNinja movie poster as being a likely region of interest. The likely regions of interest in the feature map corresponding to the portion of the image that includes the Cowboy RoboNinja movie poster may then be sent to a second machine learning model that may be used to extract deep-learning (DL)-feature representations of the likely regions of interest. Local-feature descriptors may also be extracted from each of the likely regions of interest in the image. These local-feature descriptors may correspond to points of interest with a likely region of interest, and may be generated based on spatially bounded patches within the likely region of interest. For each likely region of interest, the extracted DL-feature representation may be compared against stored DL-feature representations (e.g., on a DL-feature database) to identify a set of potentially matching DL-feature representations. Each of these potentially matching DL-feature representations may be associated with an AR target of an AR effect. Building on the previous example, a DL-feature representation of the image portion including the Cowboy RoboNinja movie poster may be sent from the smartphone to a server that includes the stored DL-feature representations (e.g., a DL-feature database), and a comparison at the server may yield a set of 20 potentially matching DL-feature representations, each of which being associated with a potentially matching AR target corresponding to a movie poster. For each likely region of interest, the extracted local-feature descriptors may be compared against local-feature descriptors, which may be stored within a local-feature database, associated with the set of potentially matching DL-feature representations. The comparison of local-feature descriptors may further narrow the potentially matching DL-feature representations—for example, to a single matching DL-feature representation that may correspond to a single matching AR target. Building on the previous example, the comparison of local-feature descriptors may narrow the 20 potentially matching AR targets down to a single matching AR target—the Cowboy RoboNinja movie poster. An AR effect associated with the matching AR target may then be caused to be rendered. As an example and not by way of limitation, a user viewing the Cowboy RoboNinja movie poster on a display of a smartphone may see on the display, near the poster, an avatar of Cowboy RoboNinja.

By (1) comparing the extracted DL-feature representations against stored DL-feature representations (e.g., in a DL-feature database) and by (2) further comparing the extracted local-feature descriptors against stored local-feature descriptors (e.g., in a local-feature database), the accuracy and performance of the matching process may be vastly improved. It also serves to reduce the expenditure of computational resources, which may be particularly important when dealing with image comparisons, which is a computationally challenging task. The DL-feature comparison may be efficient at quickly narrowing down a large number of AR targets to a small subset of potentially matching AR targets. As an example and not by way of limitation, out of 12 million AR targets on the DL-feature database, 20 AR targets may be identified as potential candidates because of matching DL-feature representations. However, the DL-feature comparison process may, in some cases, lead to ambiguities. For example, an extracted DL-feature may have slight variations that may not be adequately accounted for in the stored DL-feature representations. As another example, the associated machine learning model may be trained to detect objects of one or more real-world object types (e.g., the object-type “posters” associated with the Cowboy RoboNinja poster in the image) and note specific AR targets (e.g., one that is associated with the particular Cowboy RoboNinja poster), and so the DL-feature representations may not be able to disambiguate different objects of an object-type (e.g., posters) with sufficient precision. In these cases, the local-feature comparison process may be able to disambiguate the potentially matching AR targets to accurately identify a matching AR target. In some cases, while the local-feature comparison process may be accurate, it may be time-consuming and computationally challenging to perform on a large set. By narrowing it down to small subset (e.g., 20 AR targets), both time and computational resources may be conserved in finding a matching AR target using local-feature comparisons.

Embodiments of the invention may include or be implemented in conjunction with an artificial reality system. The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example of a real-world environment being viewed through the display of a client device.

FIG. 2 illustrates an example deep-learning (DL) feature extraction process.

FIG. 3 illustrates an example of an image including a region of interest.

FIG. 4 illustrates an example local-feature extraction process.

FIG. 5 illustrates an example of a feature-matching method.

FIG. 6 illustrates an example method for identifying a matching AR target in a real-world environment and rendering an associated AR effect.

FIG. 7 illustrates an example network environment associated with a social-networking system.

FIG. 8 illustrates an example social graph.

FIG. 9 illustrates an example computer system.

### DESCRIPTION OF EXAMPLE EMBODIMENTS

Embodiments of the invention may include or be implemented in conjunction with an artificial reality system. In particular embodiments, a computing device may access an image of a real-world environment that may contain one or more depictions of real-world objects that are intended targets for AR effects. For example, this computing device may be a client computing device such as a smartphone that is viewing a real-world environment that includes a Cowboy RoboNinja movie poster for which an AR effect exists (e.g., on a server database). An initial feature map may be generated for the image using a first machine learning model. A separate machine learning model may then be used to identify likely regions of interest within the feature map and the corresponding image. Building on the previous example, if posters are targets of interest for an AR effect, a machine learning model residing on the smartphone may identify a region within the feature map corresponding to the portion of the image that includes the Cowboy RoboNinja movie poster as being a likely region of interest. The likely regions of interest in the feature map corresponding to the portion of the image that includes the Cowboy RoboNinja movie poster may then be sent to a second machine learning model that may be used to extract deep-learning (DL)-feature representations of the likely regions of interest. Local-feature descriptors may also be extracted from each of the likely regions of interest in the image. These local-feature descriptors may correspond to points of interest with a likely region of interest, and may be generated based on spatially bounded patches within the likely region of interest. For each likely region of interest, the extracted DL-feature representation may be compared against a DL-feature database to identify a set of potentially matching DL-feature representations. Each of these potentially matching DL-feature representations may be associated with an AR target of an AR effect. Building on the previous example, a DL-feature representation of the image portion including the Cowboy RoboNinja movie poster may be sent from the smartphone to a server that includes the database of DL-feature representations, and a comparison at the server may yield a set of 20 potentially matching DL-feature representations, each of which being associated with a potentially matching AR target corresponding to a movie poster. For each likely region of interest, the extracted local-feature descriptors may be compared against local-feature descriptors, which may be stored within a local-feature database, associated with the set of potentially matching DL-feature representations. The comparison of local-feature descriptors may further narrow the potentially matching DL-feature representations—for example, to a single matching DL-feature representation that may correspond to a single matching AR target. Building on the previous example, the comparison of local-feature descriptors may narrow the 20 potentially matching AR targets down to a single matching AR target—the Cowboy RoboNinja movie poster. An AR effect associated with the matching AR target may then be caused to be rendered. As an example and not by way of limitation, a user viewing the Cowboy RoboNinja movie poster on a display of a smartphone may see on the display, near the poster, an avatar of Cowboy RoboNinja.

By (1) comparing the extracted DL-feature representations against stored DL-feature representations in the DL-feature database and by (2) further comparing the extracted local-feature descriptors against the local-feature database, the accuracy and performance of the matching process may be vastly improved. It also serves to reduce the expenditure of computational resources, which may be particularly important when dealing with image comparisons, which is a computationally challenging task. The DL-feature comparison may be efficient at quickly narrowing down a large number of AR targets to a small subset of potentially matching AR targets. As an example and not by way of limitation, out of 12 million AR targets on the DL-feature database, 20 AR targets may be identified as potential candidates because of matching DL-feature representations. However, the DL-feature comparison process may, in some cases, lead to ambiguities. For example, an extracted DL-feature may have slight variations that may not be adequately accounted for in the stored DL-feature representations. As another example, the associated machine learning model may be trained to detect objects of one or more real-world object types (e.g., the object-type “posters” associated with the Cowboy RoboNinja poster in the image) and note specific AR targets (e.g., one that is associated with the particular Cowboy RoboNinja poster), and so the DL-feature representations may not be able to disambiguate different objects of an object-type (e.g., posters) with sufficient precision. In these cases, the local-feature comparison process may be able to disambiguate the potentially matching AR targets to accurately identify a matching AR target. In some cases, while the local-feature comparison process may be accurate, it may be time-consuming and computationally challenging to perform on a large set. By narrowing it down to small subset (e.g., 20 AR targets), both time and computational resources may be conserved in finding a matching AR target using local-feature comparisons.

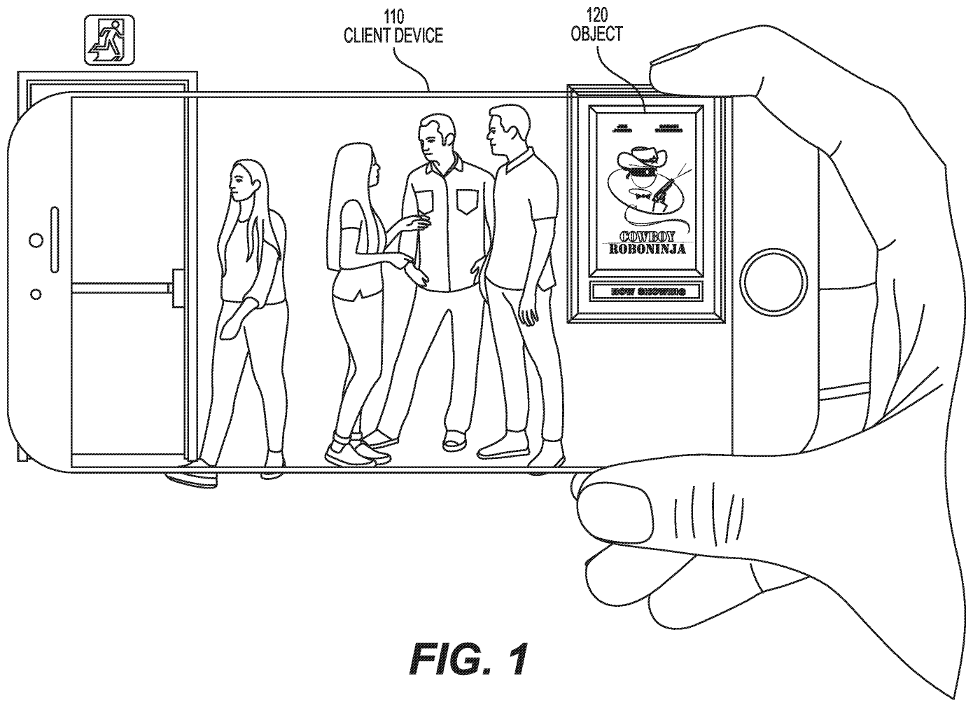

FIG. 1 illustrates an example of a real-world environment being viewed through the display of a client device. In particular embodiments, a computing device may access an image of a real-world environment. In particular embodiments, the image may have been captured by a camera or other sensor of a client device (e.g., a smartphone, a tablet, a wearable device) of a user. In particular embodiments, the computing device may be the client device of the user. In particular embodiments, the computing device may be a server computing machine (e.g., a remote server of the social-networking system 760 described herein), in which case the computing device may access the image after it is received from a client device. In particular embodiments, tasks performed by the computing device, as described herein, may be performed in part by a client device and in part by a server computing machine. In particular embodiments, the image may be accessed at any suitable point in time. As an example and not by way of limitation, the client device may access the image from a memory cache of the client device immediately or almost immediately after the point of capture such that the image may be said to be accessed in real-time as a user views a real-world environment with a client device. For example, referencing FIG. 1, a user of the client device 110 may be viewing a movie theater lobby through a display of the client device 110 (e.g., while an AR app is being executed on the client device 110). In this example, the computing device may continuously access a stream of images as the user continues to view the movie theater lobby. As another example and not by way of limitation, the image may be a pre-recorded image. For example, a user may be viewing a pre-recorded video (in which case a frame from the video may be extracted as an image) or a photo that was previously captured.

In particular embodiments, the image may comprise a depiction of an object, such as a real-world object or a virtual object. As an example and not by way of limitation, referencing FIG. 1, the image being viewed on the client device 110 includes a depiction of the object 120, which may correspond to a real-world Cowboy RoboNinja movie poster. As another example and not by way of limitation, the object may be a virtual object, such as a computer-generated unicorn, that was placed by another user. Other examples of objects of interest include street signs, product logos, and landmarks (e.g., the Eiffel Tower).

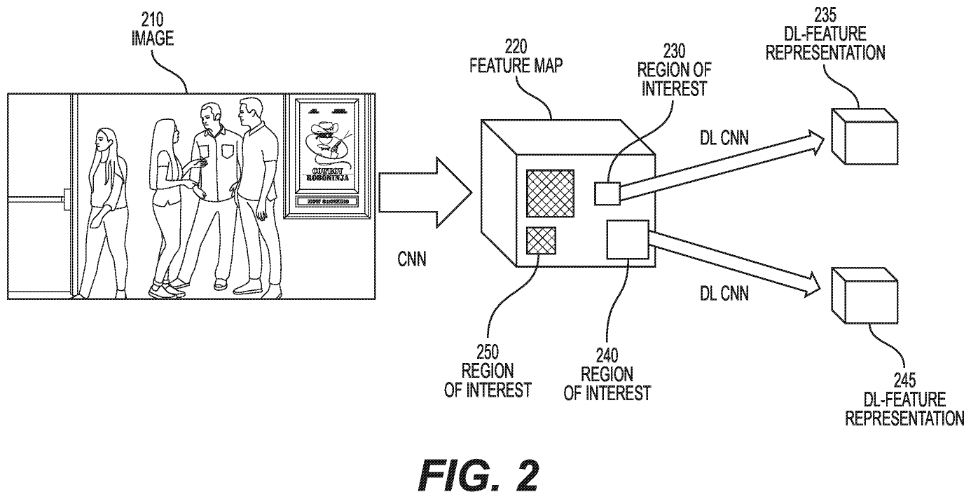

FIG. 2 illustrates an example deep-learning (DL) feature extraction process. In particular embodiments, the computing device may generate an initial feature map associated with the image. In particular embodiments, this initial feature map may be generated using a machine learning model. As an example and not by way of limitation, the initial feature map may be generated using a convolutional neural network (CNN) that may employ a ResNet-50 architecture. The generated initial feature map may include information that codes various features of the image. As an example and not by way of limitation, referencing FIG. 2, the image 210 may be passed through a CNN (or other machine learning model) to output the feature map 220, which may include information coding for various features of the image 210.

In particular embodiments, a computing device may identify one or more proposed regions of interest within the initial feature map. Referencing FIG. 2, the computing device may identify, within the feature map 220, several regions of interest (e.g., the regions of interest 230, 240, and 250). In particular embodiments, each of these regions of interest may be associated with different features in the image. In particular embodiments, the regions of interest may be associated with features that likely correspond to portions of the image that are associated with objects of interest. As an example and not by way of limitation, referencing FIG. 2, the region of interest 230 may include information coding for a portion of the image 210 (e.g., a corner of a picture within the Cowboy RoboNinja poster depicted in the image 210). In particular embodiments, the identification of the regions of interest may be performed by a region proposal network (RPN), which may be, for example, a CNN that is trained to identify features that likely correspond to portions of the image (e.g., each portion defined by a bounding box) that are associated with certain objects. As an example and not by way of limitation, the RPN may be trained to identify features corresponding to movie posters in the image (e.g., referencing FIG. 1, the Cowboy RoboNinja movie poster corresponding to the object 120).

In particular embodiments, a computing device may select, from the one or more proposed regions of interest, one or more likely regions of interest. One or more of these likely regions of interest may be associated with a portion of the image corresponding to an object of interest. As an example and not by way of limitation, referencing FIG. 1, a likely region of interest may include a portion of the depiction of the Cowboy RoboNinja movie poster corresponding to the object 120. In particular embodiments, the RPN may calculate, for each proposed region of interest, a confidence score that may correspond to the likelihood that the proposed region of interest is associated with an object of interest. As an example and not by way of limitation, the confidence score may be calculated based on a machine learning model. For example, in the case of an RPN that has been trained to identify movie posters, a feature that includes information coding for a shape that is rectangular may receive a higher confidence score than a feature that includes information coding for a shape that is circular. In particular embodiments, the likely regions of interest may be proposed regions of interest that have a confidence score greater than a threshold confidence score.

In particular embodiments, a computing device may extract, from one or more of the likely regions of interest of the feature map, one or more deep-learning (DL)-feature representations. In particular embodiments, a DL-feature representation may be a vector representation. In particular embodiments, each of the one or more regions of interest may be sent through a first machine learning model (e.g., a CNN) that has been trained to detect objects of one or more real-world object types (e.g., the object-type “posters” associated with the Cowboy RoboNinja poster in the image 310). As an example and not by way of limitation, an intermediate layer of a CNN or other machine learning model may output a DL-feature representation. As an example and not by way of limitation, the DL-feature representation may be an output of an average pooling layer. In this example, the average pooling layer may be the layer that would be, in a conventional classification CNN, the second-to-last layer—e.g., the layer immediately before a fully connected layer that may return a classification result.

In particular embodiments, the first machine learning model may have been trained using a deep-learning process with a training set of images that include depictions of a plurality of objects of interest. As an example and not by way of limitation, the first machine learning model may have been trained to detect movie posters by passing 10 images (e.g., different variations of the movie poster that account for different perspective skews, orientation differences, size differences, location differences, differences in lighting conditions, etc.) of each movie poster through the machine learning model. For example, 10 images containing variations of a Cowboy RoboNinja movie poster from several angles and corresponding ground-truth labels (e.g., bounding boxes or classification labels for regions in each training image where posters appear) may be passed through the machine learning model. In particular embodiments, the training images may be used to train the machine learning model in an end-to-end fashion (in other words, each training image may be sequentially processed by and used to update the initial machine learning model for generating feature maps, the RPN, and the first machine learning model for detecting objects of interest). These different image variations may be synthetically generated using a data augmentation process (e.g., with any suitable combination of image processing techniques that automatically varies characteristics of an original image). As an example and not by way of limitation, rotated or skewed versions of a Cowboy RoboNinja movie poster may be generated based on an original image that was captured. Alternatively, the different image variations may simply be captured under different conditions (e.g., different perspectives, orientations, sizes, locations, lighting conditions) in the real world. In particular embodiments, the different image variations may be a combination of both synthetically generated images and captured images. In particular embodiments, after the machine learning model has been trained, it may be used to extract DL-feature representations of images of AR targets and store the extracted DL-feature representations (e.g., in a DL-feature database). These DL-feature representations may be associated in the DL-feature database with corresponding AR targets and/or corresponding AR effects. As an example and not by way of limitation, a DL-feature representation may be extracted from an image of a Cowboy RoboNinja movie poster, and this DL-feature representation may serve as an index in the DL-feature database for the corresponding AR target and/or AR effects.

In particular embodiments, the DL-feature representations may be determined using this trained machine learning model. As an example and not by way of limitation, the trained machine learning model may be used to associate AR targets with associated DL-feature representations (e.g., within a DL-feature database). In particular embodiments, a DL-feature database may include a plurality of stored DL-feature representations that may be associated with a plurality of augmented-reality (AR) targets, which may be objects associated with one or more AR effects (e.g., by an index). In particular embodiments, these AR targets may correspond to real-world objects of interest, or virtual objects of interest. As an example and not by way of limitation, referencing FIG. 1, the DL-feature database may include a DL-feature representation associated with the Cowboy RoboNinja movie poster corresponding to the object 120. As an example and not by way of limitation, the DL-feature database may include a DL-feature representation associated with a computer-generated unicorn that may appear in an image.

In particular embodiments, based on the DL-feature representations extracted from an input image (e.g., image 210), a computing device may identify, from the plurality of AR targets associated with the stored DL-feature representations (e.g., in the DL-feature database), a set of potentially matching AR targets. This identification may be based on a comparison of the extracted DL-feature representations with the plurality of stored DL-feature representations. As an example and not by way of limitation, this comparison may involve vector comparisons (where each DL-feature representation may be a vector representation), so that a nearest-neighbor search may be performed to identify similar DL-feature representations in the DL-feature database. In this example, vectors of similar DL-feature representations may be located, by virtue of their similarity, within a threshold region of an d-dimensional vector space such that similar DL-feature representations may be identified by identifying all vectors within the threshold region. Alternatively or additionally, similar DL-feature representations may be identified by determining Euclidean distances or cosine similarities among vectors in the d-dimensional space. More information about determining similarities of items based on their vectors in a d-dimensional space may be found in U.S. patent application Ser. No. 15/277,938, filed 27 Sep. 2016, which is incorporated herein by reference.

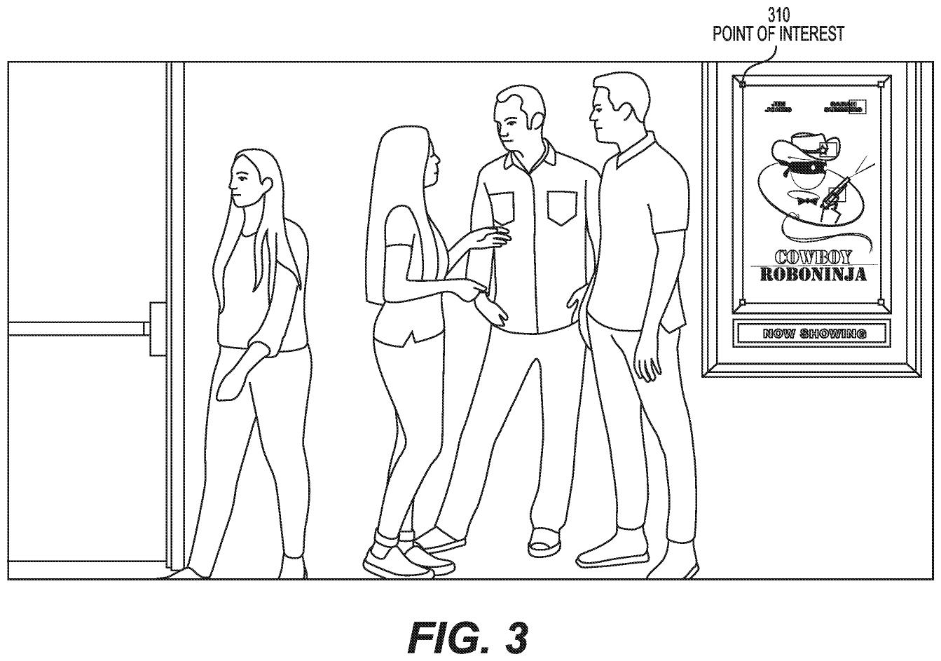

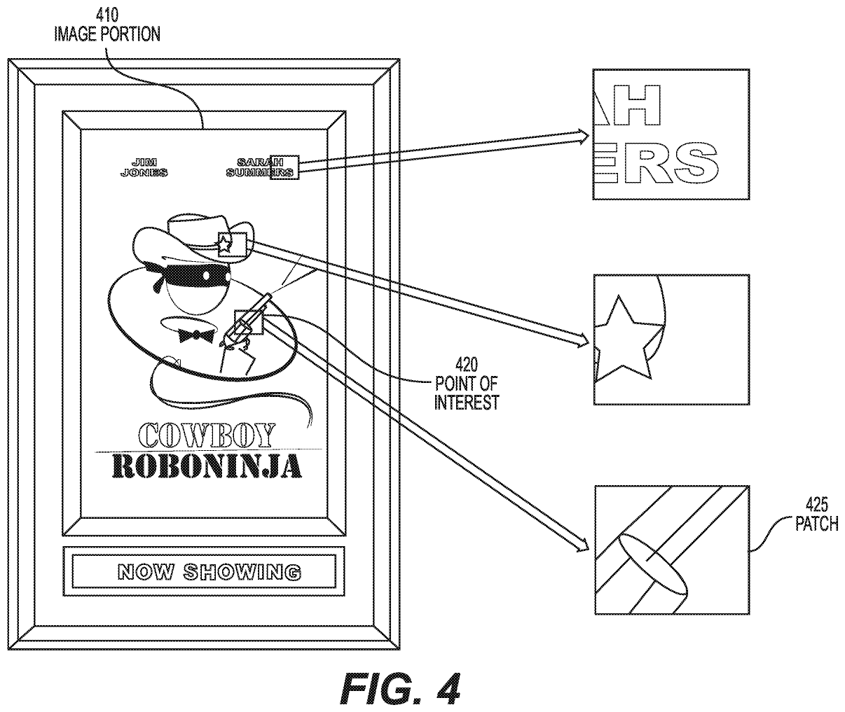

FIG. 3 illustrates an example of an image including a region of interest. In particular embodiments, one or more likely regions of interest may be identified within an image based on the results of the comparison of the extracted DL-feature representations with the plurality of stored DL-feature representations. As an example and not by way of limitation, referencing FIG. 3, the Cowboy RoboNinja movie poster may be identified as a likely region of interest within the image. FIG. 4 illustrates an example local-feature extraction process. In particular embodiments, a computing device may detect one or more points of interest within the image. In particular embodiments, only likely regions of interest may be passed on to the local-feature extraction process, in which case the computing device may only detect points of interest within portions of the image that correspond to likely regions of interest. As an example and not by way of limitation, referencing FIGS. 3 and 4, only the image portion 410 (corresponding to the Cowboy RoboNinja movie poster in the image depicted in FIG. 3) may be passed through a local-feature extraction process (e.g., because only the image portion 410 may have had a threshold confidence score), such that the computing device may only detect points of interest with the image portion 410. In particular embodiments, the detected points of interest may be corners or other visual features that are distinct from the surrounding area in the image. These points of interest may be points that are capable of being tracked in a series of related images. As an example and not by way of limitation, points of interest may be points that are capable of being continuously tracked as a user moves a client device that is capturing a series of images. One or more of these detected points of interest may be associated with an object of interest. As an example and not by way of limitation, referencing FIG. 3, the point of interest 310 may be a corner of the Cowboy RoboNinja movie poster 330.

In particular embodiments, a computing device may extract one or more local-feature descriptors from the image. These local-feature descriptors may be associated with one or more detected points of interest. As an example and not by way of limitation, referencing FIG. 4, local-feature descriptors for several points of interest (e.g., the point of interest 420) may be extracted for the image portion 410. In particular embodiments, the computing device may extract local-feature descriptors that describe one or more spatially bounded patches within the image, with each patch including a detected point of interest. A patch may be a region of the image around the detected point of interest (e.g., with the point of interest at or near the center of the patch). As an example and not by way of limitation, referencing FIG. 4, the patch 425 may correspond to the point of interest 420. In particular embodiments, a patch associated with a point of interest may be used to generate a local-feature descriptor (e.g., using a Scale Invariant Feature Transform (SIFT), using Speed Up Robust Feature (SURF)) that may function as a representation of the patch. The local-feature descriptor may include location information (e.g., an (x, y) coordinate) for the point of interest within the image. The local-feature descriptor may also include corresponding scale and orientation information. As an example and not by way of limitation, a local-feature descriptor may be represented as a vector, with the length of the vector representing scale and the direction of the vector representing orientation of the point of interest. The scale parameter may reflect, for example, size differences that may occur as a result of the distance of a camera (e.g., of a client device) that captured the image. The orientation parameter may be determined by detected gradients in lighting intensity within the patch, which may be used to find a dominant orientation that may serve as a directional anchor that describes the orientation of the patch. The local-feature descriptor for a patch may also include information that encodes visual features present in the patch. As an example and not by way of limitation, referencing FIG. 4, the local-feature descriptor for the patch 425 may include information that encodes the shapes, colors, textures, lighting intensities, and/or any other suitable visual feature of the patch.

In particular embodiments, a computing device may determine, from the set of potentially matching AR targets, a matching AR target. The matching AR target may be an AR target that is determined to be a high-probability match for the real-world object depicted in the image. As an example and not by way of limitation, referencing FIG. 1, the real-world object 120, a Cowboy RoboNinja movie poster, may be determined to match an AR target corresponding to the Cowboy RoboNinja movie poster. In particular embodiments, multiple matching AR targets may be determined.

In particular embodiments, the determination of the matching AR target may be based on a comparison of the extracted local-feature descriptors with stored local-feature descriptors associated with the set of potentially matching AR targets. The stored local-feature descriptors may be stored on a local-feature database (e.g., located locally at the client device that captured the image, located at a remote server) that may, for example, include an index associating a plurality of local-feature descriptors with a plurality of AR targets. In particular embodiments, the stored local-feature descriptors (e.g., in the local-feature database) may account for different perspectives, orientations, sizes, locations, lighting conditions, or any other potential variations by storing different versions of the local-feature descriptors that account for these variations (e.g., with synthetically generated images, or images captured at different settings). In particular embodiments, the computing device may determine a match between two local-feature descriptors by identifying a suitable transformation that may cause an extracted local-feature descriptor to match a stored local-feature descriptor using a verifier process (e.g., a geometric verifier process). As an example and not by way of limitation, referencing FIG. 4, if an image included a rotated version of the image portion 410 (e.g., if the poster was tilted by 30 degrees), the verifier process may still be able to find a match between the extracted local-feature descriptor of the patch 425 and the corresponding stored local-feature descriptor (even if the rotated version were not stored in the local-feature database) by identifying a suitable transformation that could convert the extracted local-feature descriptor (e.g., one that approximates an local-feature descriptor of a rotation of the patch by 30 degrees). In particular embodiments, the verifier process may be particularly advantageous in that it may make it unnecessary to store different version of a local feature (since the verifier process can simply identify suitable transformations for converting among variations). In particular embodiments, an image may have a plurality of local-feature descriptors that are each compared against local-feature descriptors in the local-feature database.

In particular embodiments, a DL-feature database and a local-feature database may be a single master database. As an example and not by way of limitation, the DL-feature database may associate stored DL-feature representations with corresponding stored local-feature descriptors. In this example, a DL-feature representation extracted from an image may be compared against stored DL-feature representations in the master databased to identify 20 potentially matching DL-feature representations, each of which may be associated with a respective AR target and a respective set of stored local-feature descriptors. A local-feature comparison may then compare local-feature descriptors extracted from the image against the 20 sets of stored local-feature descriptors associated with the 20 potentially matching DL-feature representations. From this local-feature comparison, a single set of local-feature descriptors may be determined to have the best match, in which case the associated AR target may be identified as a matching AR target.

In particular embodiments, determining a matching AR target may involve calculating a match-score for each potentially matching AR target. The match-score may be based on a number and/or quality of matches that are identified between the extracted local-feature descriptors of an image or image portion and the stored local-feature descriptors of a particular AR target. As an example and not by way of limitation, the more matches that are identified between the image and the particular AR target, the higher the match-score that may be calculated for the respective AR target.

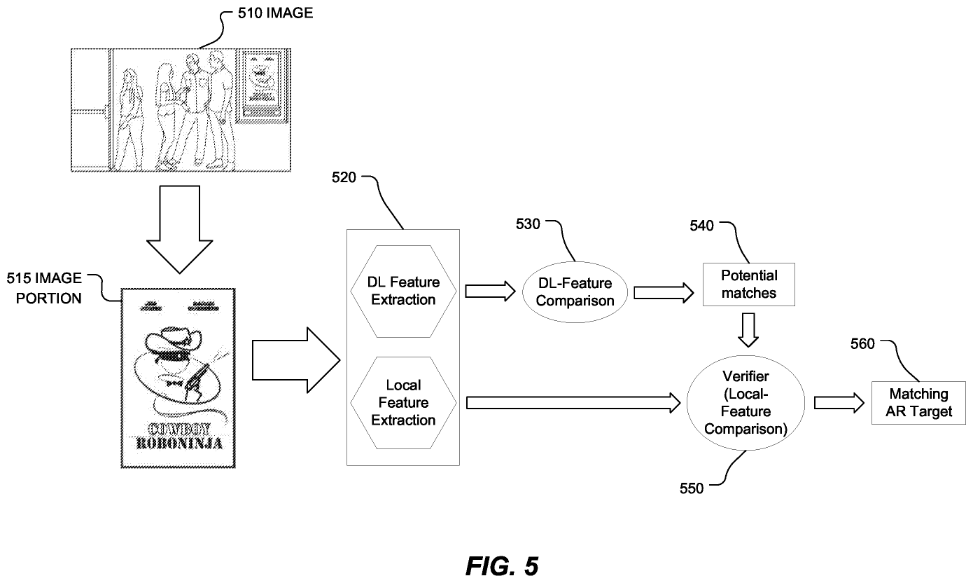

FIG. 5 illustrates an example of a feature-matching method. In particular embodiments, an image portion 515 may be determined from an image 510. The image portion 515 may be a likely region of interest (e.g., one that is proposed by an RPN, with a threshold confidence score). The image portion 515 may be passed through one or more feature-extraction processes 520 for extracting DL-feature representations and local-feature descriptors. The extracted DL-feature representations may be passed through a DL-feature comparison process 530 (e.g., a nearest-neighbor search process) to identify one or more potential matches 540. The potential matches may be passed through a verifier process 550 (e.g., a geometric verifier process) that compares the local-feature descriptors of the image 510 against the local-feature descriptors of the one or more potential matches 540. If there are two or more potential matches 540, the verifier process 550 may identify a single matching AR target 560 from the two or more potential matches 540. If there were only one potential match 540, the verifier process may simply verify that the potential match 540 is a matching target 560.

In particular embodiments, the feature-extraction processes 520 may be performed on the client device where the image 510 was captured. In these embodiments, the extracted DL-feature representations and local-feature descriptors may be sent to a server computing machine (e.g., the social-networking system 760). In these embodiments, the DL-feature comparison process 530 and the verifier process 550 may be performed at the server computing machine, which may then send AR effects associated with the matching AR target 560 back to the client device.

In particular embodiments, all the steps outlined in FIG. 5 may be performed by the server computing machine. As an example and not by way of limitation, the client device may send the image 510 (e.g., after some initial pre-processing) or the image 515 to the server, which may perform the feature-extraction processes 520, the DL-feature comparison process 530, and the verifier process 550.

In particular embodiments, all the steps outlined in FIG. 5 may be performed locally at the client device, in which case the DL-feature database and the local-feature database may reside locally on the client device. In particular embodiments, any of steps outlined in FIG. 5 may be performed by either the client device or the server computing machine in any suitable combination.

In particular embodiments, the computing device may cause one or more AR effects associated with the matching AR target to be rendered on a client device associated with a first user. In particular embodiments, in cases where the AR effects are stored on a server computing machine (e.g., in the case where the DL-feature database and the local-feature database are on the server computing machine), the server computing machine may send information configured to render the AR effects associated with the matching AR target on the client device. In particular embodiments, in cases where the AR effects are stored locally on the client device, the client device may simply retrieve information configured to render the AR effects from a local memory. In particular embodiments, the AR effects may only be rendered if the user of the client device is authorized to access the AR effects. As an example and not by way of limitation, the user may be authorized based on social-networking information associated with the user. For example, a server computing machine (e.g., the social-networking system 760) associated with a data store housing the AR effects may only send an AR effect to a user if privacy settings associated with the AR effect allow for it. As another example, the AR effect may specify other criteria that is based on particular types of user information (e.g., an age restriction that only allows an AR effect to be sent to a client device of a user who is at least 18 years old, user affinity information that only allows an AR effect to be sent to a client device of a user with a threshold affinity coefficient for the AR effect).

In particular embodiments, the AR effects may be associated with the matching AR targets. As an example and not by way of limitation, an AR effect that includes a 3D Cowboy RoboNinja avatar may be associated (e.g., in an index of a database) with the matching AR target, which may correspond to a Cowboy RoboNinja movie poster. In this example, when a Cowboy RoboNinja movie poster is detected within an image captured at a client device, the corresponding AR target may be identified and the Cowboy RoboNinja avatar may be rendered on the client device. As another example and not by way of limitation, when a user points a camera of a client device toward a landmark such as the Eiffel Tower, relevant information or animations may be rendered as AR effects. As another example and not by way of limitation, when the user points the camera of the client device toward a restaurant sign, a lunch menu may be rendered as an AR effect. As another example and not by way of limitation, when the user points the camera of the client device toward a product logo (e.g., a logo of an energy drink), relevant information such as calorie information or a product advertisement may be rendered as an AR effect. In particular embodiments, in cases where the database is on a remote server, the remote server may send the AR effects of the matching AR target to the client device. Alternatively, in cases where the database is locally stored on the client device, the client device may simply access its own memory to retrieve the AR effects.

In particular embodiments, a property of an AR effect may dictate that it be anchored to an object of interest (e.g., a real-world object that matched the AR target) when viewed through a display of the client device of a user. This may serve to make it appear as though the AR effect is a part of the user's real environment. In these embodiments, the AR effect may be rendered such that it appears to be fixed to the object even as the view shifts (e.g., as the user of the client device moves to a different location or changes perspective by shifting the orientation of the client device). As an example and not by way of limitation, a 3D avatar of Cowboy RoboNinja may persist such that it appears to be fixed to the a Cowboy RoboNinja movie poster when the movie poster is viewed through a client device. In these embodiments, the AR effect may be further aligned to the object of interest such that it scales and reorients itself based on the location of the client device, such that it accounts for perspective. As an example and not by way of limitation, a Cowboy RoboNinja avatar may become increasingly smaller as the client device moves farther away from the corresponding movie poster. As another example and not by way of limitation, when the user moves to a side of the Cowboy RoboNinja avatar, the user may see the side of the avatar (just as in the case of a real-world object). To maintain this anchoring and aligning of the AR effect, the object of interest corresponding to the AR target may be continuously tracked in real-time. Any suitable tracking algorithm may be used to perform this continuous tracking (e.g., a SLAM tracking algorithm that tracks the corners of the poster). More information about object-tracking may be found in U.S. patent application Ser. No. 15/803,428, filed 3 Nov. 2017 and U.S. patent application Ser. No. 16/112,407, filed 24 Aug. 2018, each of which is incorporated herein by reference.

Alternatively, a property of the AR effect may dictate that it is not to be anchored to the real-world object. As an example and not by way of limitation, the AR effect may be a filter effect that affects the entire view of the AR environment. For example, an AR effect for a Cowboy RoboNinja poster may include a “Wild West” filter that causes the entire view of the client device to take on a Hollywood Western theme.

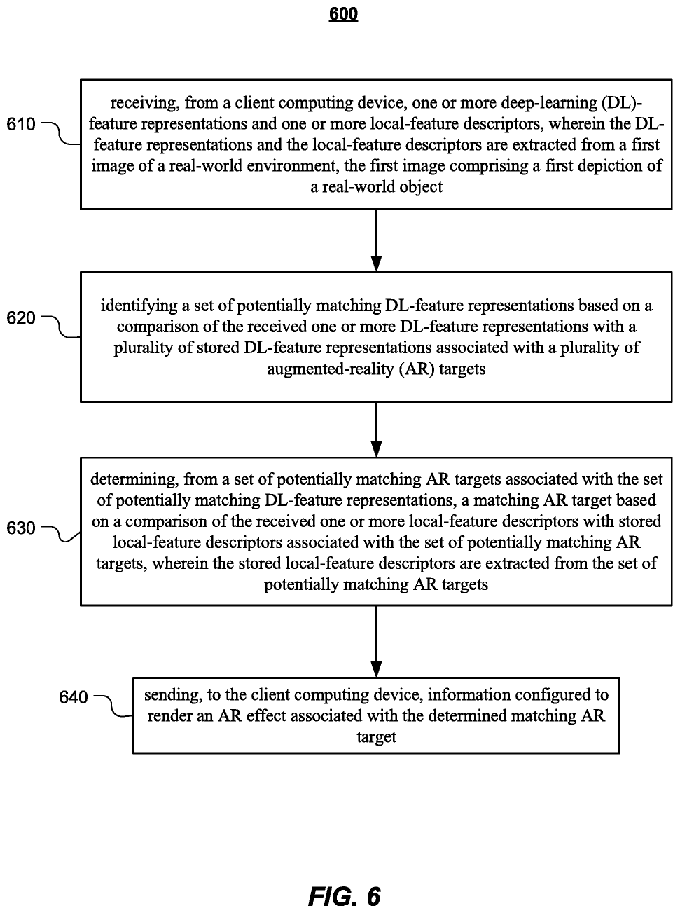

FIG. 6 illustrates an example method 600 for identifying a matching AR target in a real-world environment and rendering an associated AR effect. The method may begin at step 610, where a computing device may receive, from a client computing device, one or more deep-learning (DL)-feature representations and one or more local-feature descriptors, wherein the DL-feature representations and the local-feature descriptors are extracted from a first image of a real-world environment, the first image comprising a first depiction of a real-world object. At step 620, a computing device may identify a set of potentially matching DL-feature representations based on a comparison of the received one or more DL-feature representations with a plurality of stored DL-feature representations associated with a plurality of augmented-reality (AR) targets. At step 630, a computing device may determine, from a set of potentially matching AR targets associated with the set of potentially matching DL-feature representations, a matching AR target based on a comparison of the received one or more local-feature descriptors with stored local-feature descriptors associated with the set of potentially matching AR targets, wherein the stored local-feature descriptors are extracted from the set of potentially matching AR targets. At step 640, send, to the client computing device, information configured to render an AR effect associated with the determined matching AR target. Particular embodiments may repeat one or more steps of the method of FIG. 6, where appropriate. Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates an example method for identifying a matching AR target in a real-world environment and rendering an associated AR effect including the particular steps of the method of FIG. 6, this disclosure contemplates any suitable method for identifying a matching AR target in a real-world environment and rendering an associated AR effect including any suitable steps, which may include all, some, or none of the steps of the method of FIG. 6, where appropriate. Furthermore, although this disclosure describes and illustrates particular components, devices, or systems carrying out particular steps of the method of FIG. 6, this disclosure contemplates any suitable combination of any suitable components, devices, or systems carrying out any suitable steps of the method of FIG. 6. Some or all of the steps could be performed sequentially in any suitable order, or in parallel.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

### System Overview

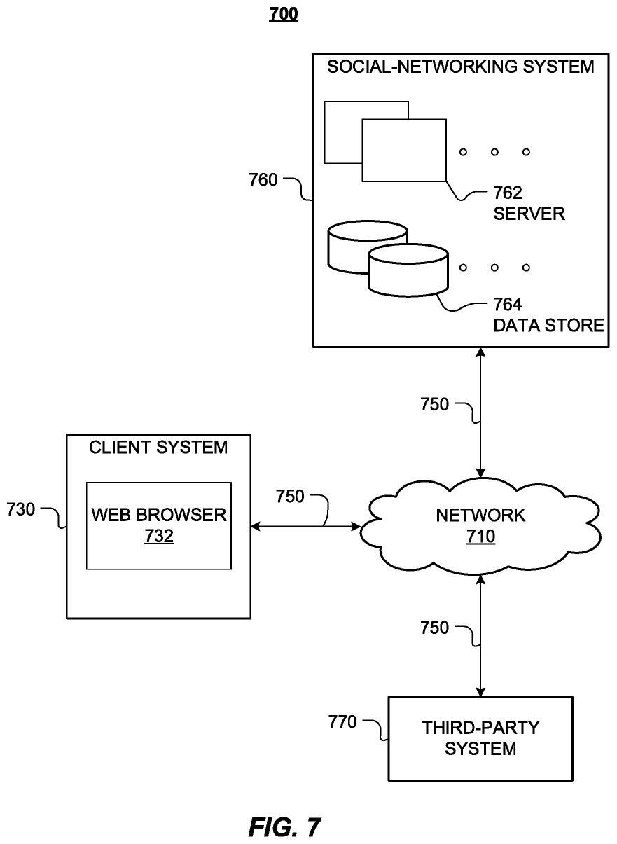

FIG. 7 illustrates an example network environment 700 associated with a social-networking system. Network environment 700 includes a client system 730, a social-networking system 760, and a third-party system 770 connected to each other by a network 710. Although FIG. 7 illustrates a particular arrangement of client system 730, social-networking system 760, third-party system 770, and network 710, this disclosure contemplates any suitable arrangement of client system 730, social-networking system 760, third-party system 770, and network 710. As an example and not by way of limitation, two or more of client system 730, social-networking system 760, and third-party system 770 may be connected to each other directly, bypassing network 710. As another example, two or more of client system 730, social-networking system 760, and third-party system 770 may be physically or logically co-located with each other in whole or in part. Moreover, although FIG. 7 illustrates a particular number of client systems 730, social-networking systems 760, third-party systems 770, and networks 710, this disclosure contemplates any suitable number of client systems 730, social-networking systems 760, third-party systems 770, and networks 710. As an example and not by way of limitation, network environment 700 may include multiple client system 730, social-networking systems 760, third-party systems 770, and networks 710.

This disclosure contemplates any suitable network 710. As an example and not by way of limitation, one or more portions of network 710 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 710 may include one or more networks 710.

Links 750 may connect client system 730, social-networking system 760, and third-party system 770 to communication network 710 or to each other. This disclosure contemplates any suitable links 750. In particular embodiments, one or more links 750 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 750 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 750, or a combination of two or more such links 750. Links 750 need not necessarily be the same throughout network environment 700. One or more first links 750 may differ in one or more respects from one or more second links 750.

In particular embodiments, client system 730 may be an electronic device including hardware, software, or embedded logic components or a combination of two or more such components and capable of carrying out the appropriate functionalities implemented or supported by client system 730. As an example and not by way of limitation, a client system 730 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 730. A client system 730 may enable a network user at client system 730 to access network 710. A client system 730 may enable its user to communicate with other users at other client systems 730.

In particular embodiments, client system 730 may include a web browser 732, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 730 may enter a Uniform Resource Locator (URL) or other address directing the web browser 732 to a particular server (such as server 762, or a server associated with a third-party system 770), and the web browser 732 may generate a Hyper Text Transfer Protocol (HTTP) request and communicate the HTTP request to server. The server may accept the HTTP request and communicate to client system 730 one or more Hyper Text Markup Language (HTML) files responsive to the HTTP request. Client system 730 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 760 may be a network-addressable computing system that can host an online social network. Social-networking system 760 may generate, store, receive, and send social-networking data, such as, for example, user-profile data, concept-profile data, social-graph information, or other suitable data related to the online social network. Social-networking system 760 may be accessed by the other components of network environment 700 either directly or via network 710. As an example and not by way of limitation, client system 730 may access social-networking system 760 using a web browser 732, or a native application associated with social-networking system 760 (e.g., a mobile social-networking application, a messaging application, another suitable application, or any combination thereof) either directly or via network 710. In particular embodiments, social-networking system 760 may include one or more servers 762. Each server 762 may be a unitary server or a distributed server spanning multiple computers or multiple datacenters. Servers 762 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 762 may include hardware, software, or embedded logic components or a combination of two or more such components for carrying out the appropriate functionalities implemented or supported by server 762. In particular embodiments, social-networking system 760 may include one or more data stores 764. Data stores 764 may be used to store various types of information. In particular embodiments, the information stored in data stores 764 may be organized according to specific data structures. In particular embodiments, each data store 764 may be a relational, columnar, correlation, or other suitable database. Although this disclosure describes or illustrates particular types of databases, this disclosure contemplates any suitable types of databases. Particular embodiments may provide interfaces that enable a client system 730, a social-networking system 760, or a third-party system 770 to manage, retrieve, modify, add, or delete, the information stored in data store 764.

In particular embodiments, social-networking system 760 may store one or more social graphs in one or more data stores 764. In particular embodiments, a social graph may include multiple nodes—which may include multiple user nodes (each corresponding to a particular user) or multiple concept nodes (each corresponding to a particular concept)—and multiple edges connecting the nodes. Social-networking system 760 may provide users of the online social network the ability to communicate and interact with other users. In particular embodiments, users may join the online social network via social-networking system 760 and then add connections (e.g., relationships) to a number of other users of social-networking system 760 to whom they want to be connected. Herein, the term “friend” may refer to any other user of social-networking system 760 with whom a user has formed a connection, association, or relationship via social-networking system 760.

In particular embodiments, social-networking system 760 may provide users with the ability to take actions on various types of items or objects, supported by social-networking system 760. As an example and not by way of limitation, the items and objects may include groups or social networks to which users of social-networking system 760 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 760 or by an external system of third-party system 770, which is separate from social-networking system 760 and coupled to social-networking system 760 via a network 710.

In particular embodiments, social-networking system 760 may be capable of linking a variety of entities. As an example and not by way of limitation, social-networking system 760 may enable users to interact with each other as well as receive content from third-party systems 770 or other entities, or to allow users to interact with these entities through an application programming interfaces (API) or other communication channels.

In particular embodiments, a third-party system 770 may include one or more types of servers, one or more data stores, one or more interfaces, including but not limited to APIs, one or more web services, one or more content sources, one or more networks, or any other suitable components, e.g., that servers may communicate with. A third-party system 770 may be operated by a different entity from an entity operating social-networking system 760. In particular embodiments, however, social-networking system 760 and third-party systems 770 may operate in conjunction with each other to provide social-networking services to users of social-networking system 760 or third-party systems 770. In this sense, social-networking system 760 may provide a platform, or backbone, which other systems, such as third-party systems 770, may use to provide social-networking services and functionality to users across the Internet.

In particular embodiments, a third-party system 770 may include a third-party content object provider. A third-party content object provider may include one or more sources of content objects, which may be communicated to a client system 730. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 760 also includes user-generated content objects, which may enhance a user's interactions with social-networking system 760. User-generated content may include anything a user can add, upload, send, or “post” to social-networking system 760. As an example and not by way of limitation, a user communicates posts to social-networking system 760 from a client system 730. Posts may include data such as status updates or other textual data, location information, photos, videos, links, music or other similar data or media. Content may also be added to social-networking system 760 by a third-party through a “communication channel,” such as a newsfeed or stream.

In particular embodiments, social-networking system 760 may include a variety of servers, sub-systems, programs, modules, logs, and data stores. In particular embodiments, social-networking system 760 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 760 may also include suitable components such as network interfaces, security mechanisms, load balancers, failover servers, management-and-network-operations consoles, other suitable components, or any suitable combination thereof. In particular embodiments, social-networking system 760 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 760 to one or more client systems 730 or one or more third-party system 770 via network 710. The web server may include a mail server or other messaging functionality for receiving and routing messages between social-networking system 760 and one or more client systems 730. An API-request server may allow a third-party system 770 to access information from social-networking system 760 by calling one or more APIs. An action logger may be used to receive communications from a web server about a user's actions on or off social-networking system 760. In conjunction with the action log, a third-party-content-object log may be maintained of user exposures to third-party-content objects. A notification controller may provide information regarding content objects to a client system 730. Information may be pushed to a client system 730 as notifications, or information may be pulled from client system 730 responsive to a request received from client system 730. Authorization servers may be used to enforce one or more privacy settings of the users of social-networking system 760. A privacy setting of a user determines how particular information associated with a user can be shared. The authorization server may allow users to opt in to or opt out of having their actions logged by social-networking system 760 or shared with other systems (e.g., third-party system 770), such as, for example, by setting appropriate privacy settings. Third-party-content-object stores may be used to store content objects received from third parties, such as a third-party system 770. Location stores may be used for storing location information received from client systems 730 associated with users. Advertisement-pricing modules may combine social information, the current time, location information, or other suitable information to provide relevant advertisements, in the form of notifications, to a user.

### Social Graphs

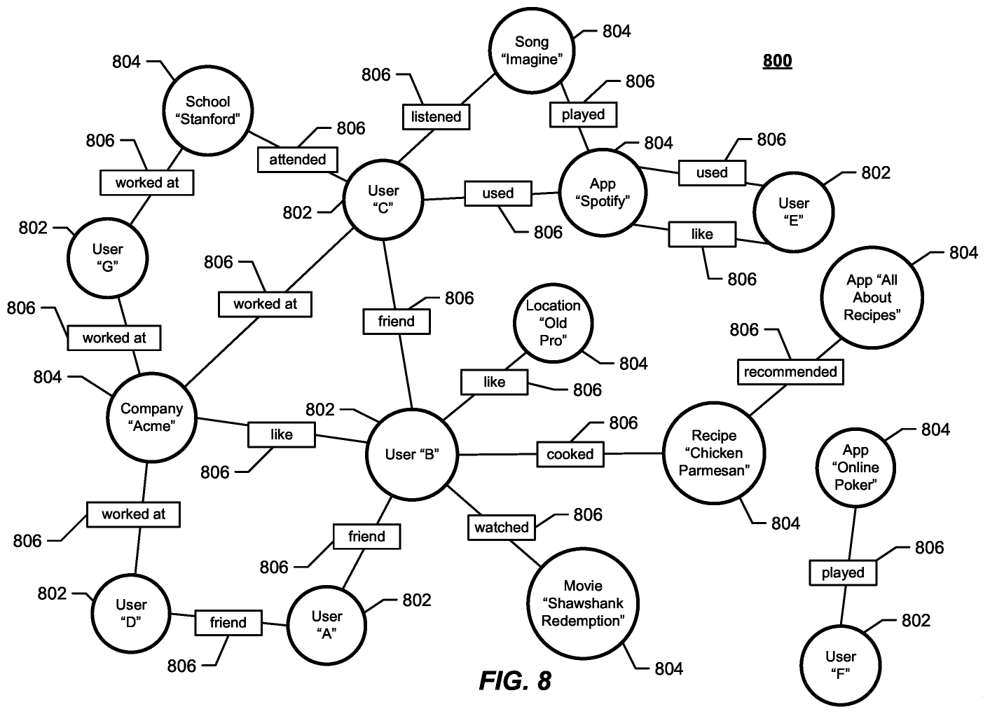

FIG. 8 illustrates example social graph 800. In particular embodiments, social-networking system 760 may store one or more social graphs 800 in one or more data stores. In particular embodiments, social graph 800 may include multiple nodes—which may include multiple user nodes 802 or multiple concept nodes 804—and multiple edges 806 connecting the nodes. Each node may be associated with a unique entity (i.e., user or concept), each of which may have a unique identifier (ID), such as a unique number or username. Example social graph 800 illustrated in FIG. 8 is shown, for didactic purposes, in a two-dimensional visual map representation. In particular embodiments, a social-networking system 760, client system 730, or third-party system 770 may access social graph 800 and related social-graph information for suitable applications. The nodes and edges of social graph 800 may be stored as data objects, for example, in a data store (such as a social-graph database). Such a data store may include one or more searchable or queryable indexes of nodes or edges of social graph 800.

In particular embodiments, a user node 802 may correspond to a user of social-networking system 760. As an example and not by way of limitation, a user may be an individual (human user), an entity (e.g., an enterprise, business, or third-party application), or a group (e.g., of individuals or entities) that interacts or communicates with or over social-networking system 760. In particular embodiments, when a user registers for an account with social-networking system 760, social-networking system 760 may create a user node 802 corresponding to the user, and store the user node 802 in one or more data stores. Users and user nodes 802 described herein may, where appropriate, refer to registered users and user nodes 802 associated with registered users. In addition or as an alternative, users and user nodes 802 described herein may, where appropriate, refer to users that have not registered with social-networking system 760. In particular embodiments, a user node 802 may be associated with information provided by a user or information gathered by various systems, including social-networking system 760. As an example and not by way of limitation, a user may provide his or her name, profile picture, contact information, birth date, sex, marital status, family status, employment, education background, preferences, interests, or other demographic information. In particular embodiments, a user node 802 may be associated with one or more data objects corresponding to information associated with a user. In particular embodiments, a user node 802 may correspond to one or more webpages.

In particular embodiments, a concept node 804 may correspond to a concept. As an example and not by way of limitation, a concept may correspond to a place (such as, for example, a movie theater, restaurant, landmark, or city); a website (such as, for example, a website associated with social-network system 760 or a third-party website associated with a web-application server); an entity (such as, for example, a person, business, group, sports team, or celebrity); a resource (such as, for example, an audio file, video file, digital photo, text file, structured document, or application) which may be located within social-networking system 760 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 804 may be associated with information of a concept provided by a user or information gathered by various systems, including social-networking system 760. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 804 may be associated with one or more data objects corresponding to information associated with concept node 804. In particular embodiments, a concept node 804 may correspond to one or more webpages.

In particular embodiments, a node in social graph 800 may represent or be represented by a webpage (which may be referred to as a “profile page”). Profile pages may be hosted by or accessible to social-networking system 760. Profile pages may also be hosted on third-party websites associated with a third-party system 770. As an example and not by way of limitation, a profile page corresponding to a particular external webpage may be the particular external webpage and the profile page may correspond to a particular concept node 804. Profile pages may be viewable by all or a selected subset of other users. As an example and not by way of limitation, a user node 802 may have a corresponding user-profile page in which the corresponding user may add content, make declarations, or otherwise express himself or herself. As another example and not by way of limitation, a concept node 804 may have a corresponding concept-profile page in which one or more users may add content, make declarations, or express themselves, particularly in relation to the concept corresponding to concept node 804.

In particular embodiments, a concept node 804 may represent a third-party webpage or resource hosted by a third-party system 770. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 730 to send to social-networking system 760 a message indicating the user's action. In response to the message, social-networking system 760 may create an edge (e.g., a check-in-type edge) between a user node 802 corresponding to the user and a concept node 804 corresponding to the third-party webpage or resource and store edge 806 in one or more data stores.

In particular embodiments, a pair of nodes in social graph 800 may be connected to each other by one or more edges 806. An edge 806 connecting a pair of nodes may represent a relationship between the pair of nodes. In particular embodiments, an edge 806 may include or represent one or more data objects or attributes corresponding to the relationship between a pair of nodes. As an example and not by way of limitation, a first user may indicate that a second user is a “friend” of the first user. In response to this indication, social-networking system 760 may send a “friend request” to the second user. If the second user confirms the “friend request,” social-networking system 760 may create an edge 806 connecting the first user's user node 802 to the second user's user node 802 in social graph 800 and store edge 806 as social-graph information in one or more of data stores 764. In the example of FIG. 8, social graph 800 includes an edge 806 indicating a friend relation between user nodes 802 of user “A” and user “B” and an edge indicating a friend relation between user nodes 802 of user “C” and user “B.” Although this disclosure describes or illustrates particular edges 806 with particular attributes connecting particular user nodes 802, this disclosure contemplates any suitable edges 806 with any suitable attributes connecting user nodes 802. As an example and not by way of limitation, an edge 806 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 800 by one or more edges 806. The degree of separation between two objects represented by two nodes, respectively, is a count of edges in a shortest path connecting the two nodes in the social graph 800. As an example and not by way of limitation, in the social graph 800, the user node 802 of user “C” is connected to the user node 802 of user “A” via multiple paths including, for example, a first path directly passing through the user node 802 of user “B,” a second path passing through the concept node 804 of company “Acme” and the user node 802 of user “D,” and a third path passing through the user nodes 802 and concept nodes 804 representing school “Stanford,” user “G,” company “Acme,” and user “D.” User “C” and user “A” have a degree of separation of two because the shortest path connecting their corresponding nodes (i.e., the first path) includes two edges 806.

In particular embodiments, an edge 806 between a user node 802 and a concept node 804 may represent a particular action or activity performed by a user associated with user node 802 toward a concept associated with a concept node 804. As an example and not by way of limitation, as illustrated in FIG. 8, a user may “like,” “attended,” “played,” “listened,” “cooked,” “worked at,” or “watched” a concept, each of which may correspond to an edge type or subtype. A concept-profile page corresponding to a concept node 804 may include, for example, a selectable “check in” icon (such as, for example, a clickable “check in” icon) or a selectable “add to favorites” icon. Similarly, after a user clicks these icons, social-networking system 760 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 760 may create a “listened” edge 806 and a “used” edge (as illustrated in FIG. 8) between user nodes 802 corresponding to the user and concept nodes 804 corresponding to the song and application to indicate that the user listened to the song and used the application. Moreover, social-networking system 760 may create a “played” edge 806 (as illustrated in FIG. 8) between concept nodes 804 corresponding to the song and the application to indicate that the particular song was played by the particular application. In this case, “played” edge 806 corresponds to an action performed by an external application (SPOTTY) on an external audio file (the song “Imagine”). Although this disclosure describes particular edges 806 with particular attributes connecting user nodes 802 and concept nodes 804, this disclosure contemplates any suitable edges 806 with any suitable attributes connecting user nodes 802 and concept nodes 804. Moreover, although this disclosure describes edges between a user node 802 and a concept node 804 representing a single relationship, this disclosure contemplates edges between a user node 802 and a concept node 804 representing one or more relationships. As an example and not by way of limitation, an edge 806 may represent both that a user likes and has used at a particular concept. Alternatively, another edge 806 may represent each type of relationship (or multiples of a single relationship) between a user node 802 and a concept node 804 (as illustrated in FIG. 8 between user node 802 for user “E” and concept node 804 for “SPOTIFY”).

In particular embodiments, social-networking system 760 may create an edge 806 between a user node 802 and a concept node 804 in social graph 800. As an example and not by way of limitation, a user viewing a concept-profile page (such as, for example, by using a web browser or a special-purpose application hosted by the user's client system 730) may indicate that he or she likes the concept represented by the concept node 804 by clicking or selecting a “Like” icon, which may cause the user's client system 730 to send to social-networking system 760 a message indicating the user's liking of the concept associated with the concept-profile page. In response to the message, social-networking system 760 may create an edge 806 between user node 802 associated with the user and concept node 804, as illustrated by “like” edge 806 between the user and concept node 804. In particular embodiments, social-networking system 760 may store an edge 806 in one or more data stores. In particular embodiments, an edge 806 may be automatically formed by social-networking system 760 in response to a particular user action. As an example and not by way of limitation, if a first user uploads a picture, watches a movie, or listens to a song, an edge 806 may be formed between user node 802 corresponding to the first user and concept nodes 804 corresponding to those concepts. Although this disclosure describes forming particular edges 806 in particular manners, this disclosure contemplates forming any suitable edges 806 in any suitable manner.

### Social Graph Affinity and Coefficient

In particular embodiments, social-networking system 760 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 770 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social-networking system 760 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social-networking system 760 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 760 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social-networking system 760 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social-networking system 760 may calculate a coefficient based on a user's actions. Social-networking system 760 may monitor such actions on the online social network, on a third-party system 770, on other suitable systems, or any combination thereof. Any suitable type of user actions may be tracked or monitored. Typical user actions include viewing profile pages, creating or posting content, interacting with content, tagging or being tagged in images, joining groups, listing and confirming attendance at events, checking-in at locations, liking particular pages, creating pages, and performing other tasks that facilitate social action. In particular embodiments, social-networking system 760 may calculate a coefficient based on the user's actions with particular types of content. The content may be associated with the online social network, a third-party system 770, or another suitable system. The content may include users, profile pages, posts, news stories, headlines, instant messages, chat room conversations, emails, advertisements, pictures, video, music, other suitable objects, or any combination thereof. Social-networking system 760 may analyze a user's actions to determine whether one or more of the actions indicate an affinity for subject matter, content, other users, and so forth. As an example and not by way of limitation, if a user frequently posts content related to “coffee” or variants thereof, social-networking system 760 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social-networking system 760 may calculate a coefficient based on the type of relationship between particular objects. Referencing the social graph 800, social-networking system 760 may analyze the number and/or type of edges 806 connecting particular user nodes 802 and concept nodes 804 when calculating a coefficient. As an example and not by way of limitation, user nodes 802 that are connected by a spouse-type edge (representing that the two users are married) may be assigned a higher coefficient than a user nodes 802 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in a first photo, but merely likes a second photo, social-networking system 760 may determine that the user has a higher coefficient with respect to the first photo than the second photo because having a tagged-in-type relationship with content may be assigned a higher weight and/or rating than having a like-type relationship with content. In particular embodiments, social-networking system 760 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 760 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 800. As an example and not by way of limitation, social-graph entities that are closer in the social graph 800 (i.e., fewer degrees of separation) may have a higher coefficient than entities that are further apart in the social graph 800.

In particular embodiments, social-networking system 760 may calculate a coefficient based on location information. Objects that are geographically closer to each other may be considered to be more related or of more interest to each other than more distant objects. In particular embodiments, the coefficient of a user towards a particular object may be based on the proximity of the object's location to a current location associated with the user (or the location of a client system 730 of the user). A first user may be more interested in other users or concepts that are closer to the first user. As an example and not by way of limitation, if a user is one mile from an airport and two miles from a gas station, social-networking system 760 may determine that the user has a higher coefficient for the airport than the gas station based on the proximity of the airport to the user.

In particular embodiments, social-networking system 760 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 760 may provide information that is relevant to user's interests and current circumstances, increasing the likelihood that they will find such information of interest. In particular embodiments, social-networking system 760 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social-networking system 760 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social-networking system 760 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 770 (e.g., via an API or other communication channel), or from another suitable system. In response to the request, social-networking system 760 may calculate the coefficient (or access the coefficient information if it has previously been calculated and stored). In particular embodiments, social-networking system 760 may measure an affinity with respect to a particular process. Different processes (both internal and external to the online social network) may request a coefficient for a particular object or set of objects. Social-networking system 760 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, filed 1 Oct. 2012, each of which is incorporated by reference.

### Privacy

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page that identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 804 corresponding to a particular photo may have a privacy setting specifying that the photo may only be accessed by users tagged in the photo and their friends. In particular embodiments, privacy settings may allow users to opt in or opt out of having their actions logged by social-networking system 760 or shared with other systems (e.g., third-party system 770). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 770, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers 762 may be authorization/privacy servers for enforcing privacy settings. In response to a request from a user (or other entity) for a particular object stored in a data store 764, social-networking system 760 may send a request to the data store 764 for the object. The request may identify the user associated with the request and may only be sent to the user (or a client system 730 of the user) if the authorization server determines that the user is authorized to access the object based on the privacy settings associated with the object. If the requesting user is not authorized to access the object, the authorization server may prevent the requested object from being retrieved from the data store 764, or may prevent the requested object from being sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

### Systems and Methods

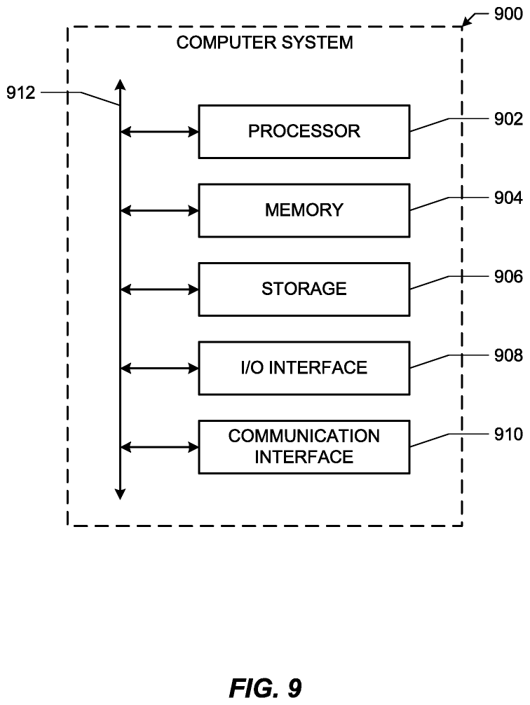

FIG. 9 illustrates an example computer system 900. In particular embodiments, one or more computer systems 900 perform one or more steps of one or more methods described or illustrated herein. In particular embodiments, one or more computer systems 900 provide functionality described or illustrated herein. In particular embodiments, software running on one or more computer systems 900 performs one or more steps of one or more methods described or illustrated herein or provides functionality described or illustrated herein. Particular embodiments include one or more portions of one or more computer systems 900. Herein, reference to a computer system may encompass a computing device, and vice versa, where appropriate. Moreover, reference to a computer system may encompass one or more computer systems, where appropriate.

This disclosure contemplates any suitable number of computer systems 900. This disclosure contemplates computer system 900 taking any suitable physical form. As example and not by way of limitation, computer system 900 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 900 may include one or more computer systems 900; be unitary or distributed; span multiple locations; span multiple machines; span multiple data centers; or reside in a cloud, which may include one or more cloud components in one or more networks. Where appropriate, one or more computer systems 900 may perform without substantial spatial or temporal limitation one or more steps of one or more methods described or illustrated herein. As an example and not by way of limitation, one or more computer systems 900 may perform in real time or in batch mode one or more steps of one or more methods described or illustrated herein. One or more computer systems 900 may perform at different times or at different locations one or more steps of one or more methods described or illustrated herein, where appropriate.

In particular embodiments, computer system 900 includes a processor 902, memory 904, storage 906, an input/output (I/O) interface 908, a communication interface 910, and a bus 912. Although this disclosure describes and illustrates a particular computer system having a particular number of particular components in a particular arrangement, this disclosure contemplates any suitable computer system having any suitable number of any suitable components in any suitable arrangement.

In particular embodiments, processor 902 includes hardware for executing instructions, such as those making up a computer program. As an example and not by way of limitation, to execute instructions, processor 902 may retrieve (or fetch) the instructions from an internal register, an internal cache, memory 904, or storage 906; decode and execute them; and then write one or more results to an internal register, an internal cache, memory 904, or storage 906. In particular embodiments, processor 902 may include one or more internal caches for data, instructions, or addresses. This disclosure contemplates processor 902 including any suitable number of any suitable internal caches, where appropriate. As an example and not by way of limitation, processor 902 may include one or more instruction caches, one or more data caches, and one or more translation lookaside buffers (TLBs). Instructions in the instruction caches may be copies of instructions in memory 904 or storage 906, and the instruction caches may speed up retrieval of those instructions by processor 902. Data in the data caches may be copies of data in memory 904 or storage 906 for instructions executing at processor 902 to operate on; the results of previous instructions executed at processor 902 for access by subsequent instructions executing at processor 902 or for writing to memory 904 or storage 906; or other suitable data. The data caches may speed up read or write operations by processor 902. The TLBs may speed up virtual-address translation for processor 902. In particular embodiments, processor 902 may include one or more internal registers for data, instructions, or addresses. This disclosure contemplates processor 902 including any suitable number of any suitable internal registers, where appropriate. Where appropriate, processor 902 may include one or more arithmetic logic units (ALUs); be a multi-core processor; or include one or more processors 902. Although this disclosure describes and illustrates a particular processor, this disclosure contemplates any suitable processor.

In particular embodiments, memory 904 includes main memory for storing instructions for processor 902 to execute or data for processor 902 to operate on. As an example and not by way of limitation, computer system 900 may load instructions from storage 906 or another source (such as, for example, another computer system 900) to memory 904. Processor 902 may then load the instructions from memory 904 to an internal register or internal cache. To execute the instructions, processor 902 may retrieve the instructions from the internal register or internal cache and decode them. During or after execution of the instructions, processor 902 may write one or more results (which may be intermediate or final results) to the internal register or internal cache. Processor 902 may then write one or more of those results to memory 904. In particular embodiments, processor 902 executes only instructions in one or more internal registers or internal caches or in memory 904 (as opposed to storage 906 or elsewhere) and operates only on data in one or more internal registers or internal caches or in memory 904 (as opposed to storage 906 or elsewhere). One or more memory buses (which may each include an address bus and a data bus) may couple processor 902 to memory 904. Bus 912 may include one or more memory buses, as described below. In particular embodiments, one or more memory management units (MMUs) reside between processor 902 and memory 904 and facilitate accesses to memory 904 requested by processor 902. In particular embodiments, memory 904 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 904 may include one or more memories 904, where appropriate. Although this disclosure describes and illustrates particular memory, this disclosure contemplates any suitable memory.

In particular embodiments, storage 906 includes mass storage for data or instructions. As an example and not by way of limitation, storage 906 may include a hard disk drive (HDD), a floppy disk drive, flash memory, an optical disc, a magneto-optical disc, magnetic tape, or a Universal Serial Bus (USB) drive or a combination of two or more of these. Storage 906 may include removable or non-removable (or fixed) media, where appropriate. Storage 906 may be internal or external to computer system 900, where appropriate. In particular embodiments, storage 906 is non-volatile, solid-state memory. In particular embodiments, storage 906 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 906 taking any suitable physical form. Storage 906 may include one or more storage control units facilitating communication between processor 902 and storage 906, where appropriate. Where appropriate, storage 906 may include one or more storages 906. Although this disclosure describes and illustrates particular storage, this disclosure contemplates any suitable storage.

In particular embodiments, I/O interface 908 includes hardware, software, or both, providing one or more interfaces for communication between computer system 900 and one or more I/O devices. Computer system 900 may include one or more of these I/O devices, where appropriate. One or more of these I/O devices may enable communication between a person and computer system 900. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 908 for them. Where appropriate, I/O interface 908 may include one or more device or software drivers enabling processor 902 to drive one or more of these I/O devices. I/O interface 908 may include one or more I/O interfaces 908, where appropriate. Although this disclosure describes and illustrates a particular I/O interface, this disclosure contemplates any suitable I/O interface.

In particular embodiments, communication interface 910 includes hardware, software, or both providing one or more interfaces for communication (such as, for example, packet-based communication) between computer system 900 and one or more other computer systems 900 or one or more networks. As an example and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 910 for it. As an example and not by way of limitation, computer system 900 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 900 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 900 may include any suitable communication interface 910 for any of these networks, where appropriate. Communication interface 910 may include one or more communication interfaces 910, where appropriate. Although this disclosure describes and illustrates a particular communication interface, this disclosure contemplates any suitable communication interface.

In particular embodiments, bus 912 includes hardware, software, or both coupling components of computer system 900 to each other. As an example and not by way of limitation, bus 912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 912 may include one or more buses 912, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a server:
receiving, from a client computing device, one or more deep-learning (DL)-feature representations and one or more local-feature descriptors, wherein the DL-feature representations and the local-feature descriptors are extracted from a first image of a real-world environment, the first image comprising a first depiction of a real-world object;
identifying a set of potentially matching DL-feature representations based on a comparison of the received one or more DL-feature representations with a plurality of stored DL-feature representations associated with a plurality of augmented-reality (AR) targets;
determining, from a set of potentially matching AR targets associated with the set of potentially matching DL-feature representations, a matching AR target based on a comparison of the received one or more local-feature descriptors with stored local-feature descriptors associated with the set of potentially matching AR targets, wherein the stored local-feature descriptors are extracted from the set of potentially matching AR targets; and
sending, to the client computing device, information configured to render an AR effect associated with the determined matching AR target.

2. The method of claim 1, wherein the one or more DL-feature representations are extracted at the client computing device by:
accessing the first image;
generating, by a first machine learning model, an initial feature map associated with the first image;
identifying one or more proposed regions of interest within the initial feature map;
selecting, from the one or more proposed regions of interest, one or more likely regions of interest, wherein each region of interest is associated with at least a first real-world-object type, and wherein one of the likely regions of interest is associated with a portion of the first image corresponding to the first depiction of the real-world object; and
extracting, from a likely region of interest, the one or more DL-feature representations, wherein each extracted DL-feature representation is an output of a second machine learning model that is trained to detect at least objects of the first real-world-object type.

3. The method of claim 2, wherein the one or more local-feature descriptors are extracted at the client computing device by:
extracting, from a portion of the first image associated with one of the likely regions of the interest, one or more local-feature descriptors associated with one or more detected points of interest, wherein each local-feature descriptor is generated based on information associated with a spatially bounded patch within the first image, the spatially bounded patch comprising a respective detected point of interest.

4. The method of claim 2, wherein selecting the likely regions of interest comprises:
calculating, for each proposed region of interest, a confidence score based on a third machine learning model; and
selecting, as likely regions of interest, one or more of the proposed regions of interest having a confidence score greater than a threshold confidence score.

5. The method of claim 2, wherein the second machine learning model is a convolutional neural network, and wherein each extracted DL-feature representation is an output of an average pooling layer of the convolutional neural network.

6. The method of claim 2, wherein the stored DL-feature representations are determined by a process comprising:
passing a plurality of second images comprising second depictions of the real-world object, wherein each of the plurality of second images comprises a variation of the first depiction of the real-world object; and
extracting, from each of the plurality of second images, one or more DL-feature representations.

7. The method of claim 6, further comprising:
representing the DL-feature representations extracted from the plurality of second images as vector representations; and
based on the respective vector representations, associating the DL-feature representations with respective AR targets.

8. The method of claim 6, wherein one or more of the plurality of second images are synthetically generated using a data augmentation process that automatically varies one or more conditions in the first image to generate one or more second images.

9. The method of claim 8, wherein the one or more conditions comprise one or more of: perspectives, orientations, sizes, locations, and lighting conditions.

10. The method of claim 1, wherein the comparison of the received one or more DL-feature representation with the plurality of stored DL-feature representations comprises a nearest-neighbor search.

11. The method of claim 1, wherein the one or more detected points of interest are corners detected within the first image.

12. The method of claim 1, wherein one or more of the detected points of interest are associated with the real-world object within the first image.

13. The method of claim 1, wherein the AR effect is anchored to the real-world object, wherein the real-world object is continuously tracked in real-time.

14. The method of claim 13, wherein the AR effect is configured to scale itself based on a location and orientation of the client computing device.

15. The method of claim 1, wherein the AR effect is a filter effect.

16. The method of claim 1, further comprising: authorizing the user of the client device to receive the AR effect associated with the determined matching AR target based on information associated with the user.

17. The method of claim 16, wherein the information associated with the user comprises user affinity information, wherein the user affinity information comprises an affinity coefficient between the user and the AR effect.

18. One or more computer-readable non-transitory storage media embodying software that is operable when executed to:
receive, from a client computing device, one or more deep-learning (DL)-feature representations and one or more local-feature descriptors, wherein the DL-feature representations and the local-feature descriptors are extracted from a first image of a real-world environment, the first image comprising a first depiction of a real-world object;
identify a set of potentially matching DL-feature representations based on a comparison of the received one or more DL-feature representations with a plurality of stored DL-feature representations associated with a plurality of augmented-reality (AR) targets;
determine, from a set of potentially matching AR targets associated with the set of potentially matching DL-feature representations, a matching AR target based on a comparison of the received one or more local-feature descriptors with stored local-feature descriptors associated with the set of potentially matching AR targets, wherein the stored local-feature descriptors are extracted from the set of potentially matching AR targets; and
send, to the client computing device, information configured to render an AR effect associated with the determined matching AR target.

19. The media of claim 18, wherein the one or more DL-feature representations are extracted at the client computing device by:
accessing the first image;
generating, by a first machine learning model, an initial feature map associated with the first image;
identifying one or more proposed regions of interest within the initial feature map;
selecting, from the one or more proposed regions of interest, one or more likely regions of interest, wherein each region of interest is associated with at least a first real-world-object type, and wherein one of the likely regions of interest is associated with a portion of the first image corresponding to the first depiction of the real-world object; and
extracting, from a likely region of interest, the one or more DL-feature representations, wherein each extracted DL-feature representation is an output of a second machine learning model that is trained to detect at least objects of the first real-world-object type.

20. A system comprising: one or more processors; and one or more computer-readable non-transitory storage media coupled to one or more of the processors and comprising instructions operable when executed by one or more of the processors to cause the system to:
receive, from a client computing device, one or more deep-learning (DL)-feature representations and one or more local-feature descriptors, wherein the DL-feature representations and the local-feature descriptors are extracted from a first image of a real-world environment, the first image comprising a first depiction of a real-world object;
identify a set of potentially matching DL-feature representations based on a comparison of the received one or more DL-feature representations with a plurality of stored DL-feature representations associated with a plurality of augmented-reality (AR) targets;
determine, from a set of potentially matching AR targets associated with the set of potentially matching DL-feature representations, a matching AR target based on a comparison of the received one or more local-feature descriptors with stored local-feature descriptors associated with the set of potentially matching AR targets, wherein the stored local-feature descriptors are extracted from the set of potentially matching AR targets; and
send, to the client computing device, information configured to render an AR effect associated with the determined matching AR target.
